(19) United States
(12) Patent Application Publication
(10) Pub. No.: US 2002/0175997 A1
(43) Pub. Date: Nov. 28, 2002

(54) Surveillance recording device and method

(75) Inventors: Yuji Takata, Yokohama (JP); Shogo Hamasaki, Kasuya-Gun (JP); Hideaki Matsuo, Fukuoka (JP); Kazuyuki Imagawa, Fukuoka (JP); Masafumi Yoshizawa, Chilkushino (JP)

Correspondence Address: DARBY & DARBY P.C., Post Office Box 5257, New York, NY, 10150-5257, US

(73) Assignee: Matsushita Electric Industrial Co., Ltd.

(21) Appl. No.: 10/153,440

(22) Filed: May 21, 2002

(30) Foreign Application Priority Data
May 22, 2001 (JP) 2001-151827

(51) Int. Cl. H04N 7/18

(52) U.S. Cl. 348/143; 382/181; 382/190

(57) ABSTRACT

A surveillance recording device using cameras extracts facial images and whole body images of a person from images shot by the cameras. A height is calculated from the whole body images. Retrieval information, including a facial image (best shot), is associated with images in a recording medium and recorded into a database. The recorded data are utilized as an index for later retrieval from the recording medium. Facial images are displayed in a list of thumbnails to make it easy to retrieve a target person on a thumbnail screen. The images are displayed together with a moving image of a target person.

### BACKGROUND OF THE INVENTION

1. Field of the Invention

The present invention relates to a surveillance recording device and method for surveilling the comings and goings of people with a camera.

2. Description of the Related Art

In facilities having objects to be protected, such as, for example, a bank, a surveillance camera is set up to surveille the comings and goings of people. Time lapse video has been used as one such conventional surveillance recording device which can record images over a long period of time. Time lapse video is a device for compressing images obtained from a camera and storing the images onto a VHS video tape over a long period of time.

In this device, in order to reduce the amount of data to be recorded, images inputted from a camera are recorded at fixed frame intervals while skipping intermediate frames. The skipping of frames lowers the image quality. However, skipping frames permits recording onto a videotape for a relatively long period of time with a particular tape length, compared to continuous recording.

Another method for reducing tape usage, and consequent increased capacity includes compressing video images before recording using, for example, an image compression technique such as a conventional MPEG compression protocol.

In conventional time lapse video, it is difficult to view recorded images since the level of image quality is poor. There is a possibility that the identity of an entering person cannot be distinguished. Furthermore, because of skipping frames between recorded frames, a key scene may occur during the skipped period. This raises the possibility that the scene including the person who has entered may not be recorded.

In addition to the abovementioned problems, the conventional surveillance recorder simply captures camera images. Therefore, after finishing recording, it is very difficult for an operator to search a target scene or person from long and massive image records.

For example, when a number of visitors enter the facility, in order to search for an image of a target person from long and massive image records, an operator searches for him/her while viewing all recorded images. This work is so troublesome and tiresome that operator fatigue may cause the image of a particular person to be missed.

### OBJECTS AND SUMMARY OF THE INVENTION

Therefore, an object of the invention is to provide a surveillance recording device and related techniques by which it becomes possible for an operator to easily search for a target person.

A surveillance recording device according to a first aspect of the invention comprises cameras for shooting a target space, an image recording and reproducing unit for recording images shot by the cameras onto a recording medium and reproducing images from the recording medium, an essential image extracting unit for extracting essential images of a person from images shot by the cameras, and a retrieval information recording unit for recording retrieval information including the essential images.

By this construction, an operator can easily search for a target image by utilizing retrieval information.

In a surveillance recording device according to a second aspect of the invention, facial images of people are included in the essential images.

By this construction, the operator can easily intuitively carry out retrieval while referring to facial images of people.

In a surveillance recording device according to a third aspect of the invention, whole body images of people are included in the essential images.

By this construction, an operator can easily carry out retrieval based on physical characteristics or clothing while referring to the whole body images of people.

A surveillance recording device according to a fourth aspect of the invention comprises a personal characteristics detecting unit for detecting the personal characteristics based on the essential images extracted by the essential image extracting unit, and the retrieval information includes the personal characteristics.

By this construction, an operator can easily carry out retrieval based on personal characteristics of people.

In a surveillance recording device according to a fifth aspect of the invention, personal characteristics include the heights of people.

By this construction, an operator can easily carry out retrieval based on the height of a person.

A surveillance recording device according to a sixth aspect of the invention comprises a best shot selecting unit for selecting a best shot among facial images of people, and the retrieval information includes the best shot facial image.

By this construction, retrieval can be carried out by using the clearest facial images.

A surveillance recording device according to a seventh aspect of the invention comprises a display unit and a display image generating unit for generating images to be displayed on the display unit, wherein the display image generating unit generates a thumbnail screen for displaying a list of essential images of people.

By this construction, an operator can easily narrow down a target person on the thumbnail screen.

In a surveillance recording device according to an eighth aspect of the invention, the display image generating unit generates a detailed information screen relating to a specific thumbnail specified on the thumbnail screen, and this detailed information screen includes essential images of a person, the personal characteristics, and the person shooting time.

By this construction, an operator can narrow down a target person on the facial image thumbnail screen and review detailed information relating to the person, whereby the operator can efficiently carry out retrieval.

In a surveillance recording device according to a ninth aspect of the invention, the image recording and reproducing unit records images only in sections of a scene in which the essential image extracting unit has been able to extract essential images.

By this construction, useless images which do not include a person, but only background scenes are not recorded, so that a recording medium can be efficiently used.

A surveillance recording device according to a tenth aspect of the invention comprises at least cameras for stereoscopically shooting a target space, an image recording and reproducing unit for recording images shot by the cameras into a recording medium and reproducing images from this recording medium, a detection wall setting unit for setting a detection wall for detection of entry of people into the target space, and a collision detecting unit for detecting whether or not people collide with the detection wall, wherein the detection wall is a virtual wall composed of a plurality of voxels (three-dimensional volumes of space) depending on the positional relationship with the cameras, and the thickness of this detection wall is set to be sufficiently small with respect to the depth of the target space.

By this construction, only important sections are surveilled, and the calculation amount is reduced, whereby a speed increase and a saving of system resources can be achieved at the same time. Furthermore, the entry of people can be detected using only the cameras that are already installed in the surveillance recording device in advance, so that additional equipment such as a special sensor is unnecessary.

In a surveillance recording device according to an eleventh aspect of the invention, the essential image extracting unit extracts essential images of a person after the collision detecting unit detects collision of a person, and the retrieval information includes the time at which the collision detecting means detects collision of the person.

By this construction, useless extraction processes that would otherwise be performed until the person collides with the detection wall is eliminated, an operator can easily retrieve images, using the time of detection as a key.

In a surveillance recording device according to a twelfth aspect of the invention, the image recording and reproducing unit starts recording images shot by the cameras after the collision detecting unit detects collision of a person.

By this construction, useless image recording before a person collides with the detection wall is eliminated, the capacity of a recording medium can be efficiently used, and the time for seeking within the recording medium during retrieval can be reduced.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram of a surveillance recording device according to an embodiment of the invention.

FIG. 2 is an explanatory view of a detection wall of the surveillance recording device of FIG. 1.

FIG. 3(a) is an illustration of an image shot by cameras of the surveillance recording device of FIG. 1.

FIG. 3(b) is an illustration of the facial image of the surveillance recording device of FIG. 1.

FIG. 3(c) is an illustration of the whole body image of the surveillance recording device of FIG. 1.

FIG. 4 is an illustration of a template for facial direction judgment.

FIG. 5 is a flowchart of the surveillance recording device of FIG. 1.

FIG. 6 is a status transition drawing of a display screen of the surveillance recording device of FIG. 1.

FIG. 7(a) is an illustration of a retrieval screen of the surveillance recording device of FIG. 1.

FIG. 7(b) is an illustration of a thumbnail screen of the surveillance recording device of FIG. 1.

FIG. 7(c) is an illustration of a detailed information screen of the surveillance recording device of FIG. 1.

### DETAILED DESCRIPTION OF THE PREFERRED EMBODIMENT

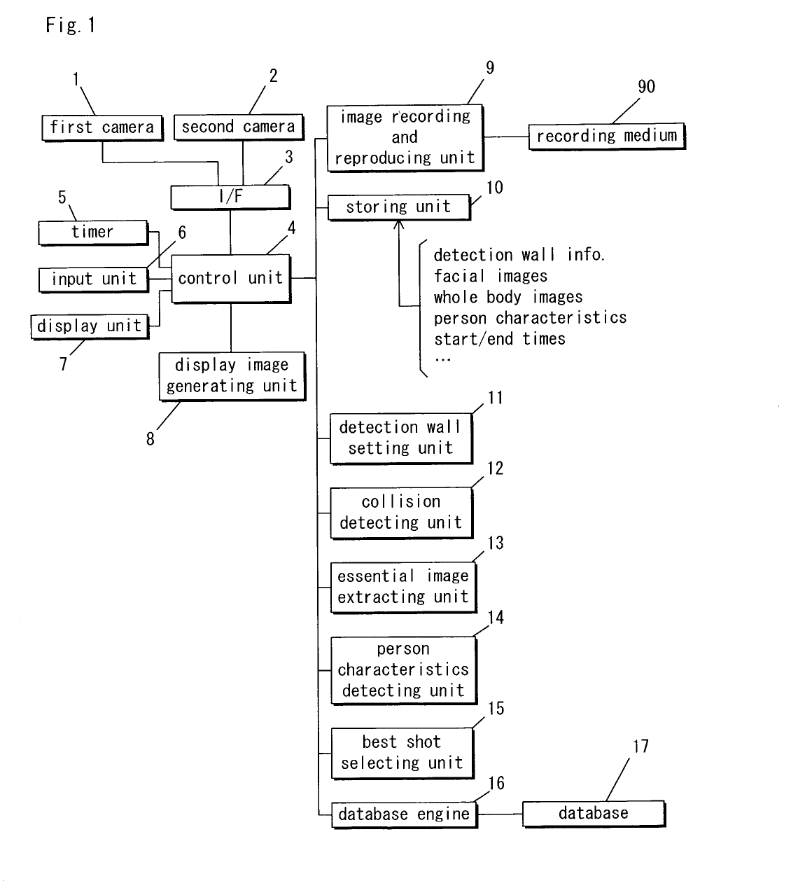

Referring to FIG. 1, the surveillance recording device according to the invention includes a first camera 1 and a second camera 2. Alternatively, if stereo vision is possible using a single stereo camera, only one stereo camera is sufficient. The number of cameras may be increased to three or more. Cameras 1 and 2 may be of types whose installation positions and parameters have been generally known. The positional relationship of the cameras 1 and 2 is described in detail later.

A control unit 4 controls the respective components shown in FIG. 1. Camera images shot by the first camera 1 and second camera 2 are inputted into the control unit 4 via an interface 3.

A timer 5 supplies information including the current date and time to the control unit 4. An input unit 6 includes a keyboard and a mouse. The input unit 6 is used by an operator to input information such as detection wall information described later, recording start/end information, and retrieval information into the device.

A display unit 7, which may be an LCD or CRT, displays images required by an operator. The images to be displayed on the display unit 7 are generated by a display image generating unit 8 in procedures described later.

An image recording and reproducing unit 9 reads and writes into a recording medium 90, and stores and reproduces moving images. Typically, the recording medium 90 is a large capacity digital recording and reproducing medium such as a DVD or DVC. The image recording and reproducing unit 9 is a player for driving this medium. Considering the operation time such as index search or fast-forwarding in reproduction of a recording medium, use of such a large capacity digital image recording and reproducing medium is advantageous. However, if operation time is not regarded as important, an analog medium such as a VHS may be used. The recording format is optional, however, a format such as MPEG (Motion Picture Expert Group) coding in which images are compressed is desirable for recording over a long period of time without noticeable lowering in the apparent image quality.

A storing unit 10 is a memory or a hard disk, which is read and written by the control unit 4. Storing unit 10 stores information including detection wall information, facial images, whole body images, personal characteristics, and start/end times.

A detection wall setting unit 11 sets a detection wall described later. A collision detecting unit 12 detects whether or not a person collides with the detection wall.

An essential image extracting unit 13 extracts essential images showing personal characteristics from images shot by the cameras 1 and 2. In this embodiment, essential images are facial images and whole body images.

A personal characteristics detecting unit 14 detects personal characteristics. In this embodiment, the heights of people, calculated based on the whole body images, are used as personal characteristics. The weights of people, as estimated from their heights, may be used as a personal characteristic. Personal characteristics may also include gender, age bracket, body type, skin or hair color, and eye color.

A best shot selecting unit 15 selects best shots that most clearly show personal characteristics among essential images extracted by the essential image extracting unit 13. In this embodiment, when several facial images of a subject are available, the best shot selecting unit 15 chooses an image showing a full face, and identifies this image as a best shot. As such a best shot, a facial image may be optionally selected if facial characteristics can be easily recognized in the image.

In information stored in the storing unit 10, information such as facial images (best shots), whole body images, personal characteristics, and start/end time that can be utilized as indexes for retrieval of moving images within the storing unit 10. The indexes are later recorded in a database 17 as moving image retrieval information. A database engine 16 retrieves the data from the database 17 or registers information into the database 17 under control of the control unit 4.

The database 17 corresponds to the retrieval information recording means in claims hereof Moving image retrieval information may be directly recorded into a recording medium 90 without especially providing databases or database engines if the format of the recording medium 90 allows for such.

In this case, the “recording medium” and “retrieval information recording means” in claims hereof are integrated, and this construction is also included in the present invention.

As above, two constructions, that is, a construction in which a “recording medium” and a “retrieval information recording means” in claims hereof are integrated together and a construction in which a “recording medium” and “retrieval information recording means” in claims hereof are separated from each other are described. Whichever construction is employed, typically, by using the format of MPEG7, retrieval information, moving images and still images shot by the cameras 1 and 2 or other necessary data (hereinafter, referred to as “quoting data” may be quoted in metadata (the format may be binary or ASCII).

In this case, metadata and quoting data may, or may not, be in the same recording medium. For example, quoting data may be quoted via a network from a recording medium including the existence of metadata.

Herein, by using the format of MPEG7, in metadata, descriptors are used to categorize quoting data. While classifying retrieval information, pieces of data having a mutual relationship can be collectively and smartly quoted. This construction is also included in the present invention.

Referring now to a detection wall may include an entry in one wall surface 21 of a target space 20. The entry includes doors 22 and 23 in a manner enabling them to be opened and closed. The surveillance recording device of this embodiment surveilles movements of people and objects entering the target space 20 (in the direction of the arrow N).

The first camera 1 and second camera 2 are installed with their fields of view facing the wall surface 21. The relative positional relationship and parameters of the cameras are generally known.

A detection wall 24 (a virtual wall) is defined slightly in front of the doors 22 and 23. This detection wall 24 is a virtual thin wall parallel to the real wall surface 21 in this example, The inside of the detection wall 24 is made up of a number of voxels 25. Preferably, the detection wall 24 is as thin as possible in order to reduce the amount of detection processing. For example, as shown in the figure, the thickness of the detection wall is set to one voxel. The thickness of the detection wall 24 may be set to be equivalent two or more voxels. However, at a minimum, the thickness is defined to be small with respect to the depth of the target space 20 (the length in the arrow N direction).

As mentioned above, in the present embodiment, two cameras 1 and 2 are set so as to have points of view that are different from each other. The cameras 1 and 2 shoot the wall surface 21 side from different directions.

When a person enters the inside of the target space 20 from the entry in the wall surface 21, a silhouette of the person is detected in the image planes of the respective cameras 1 and 2. When the person advances inside the target space 20 and collides with the detection wall 24, this collision is detected by the following procedures. The detection wall 24 is a virtual wall. Therefore, even when the person collides with the detection wall, he/she is not obstructed from advancing at all, does not recognize the collision, and passes through the detection wall 24.

Whether or not the voxels composing the detection wall 24 overlap the person is determined in accordance with the following principles.

Voxels that do not overlap the person are outside the person image in the camera image of at least one of the cameras 1 and 2. Voxels that overlap the person are inside the person images in camera images of all cameras.

In other words, if a certain voxel is within person images in camera images of all cameras, then that voxel overlaps the person. On the contrary, if a voxel is outside a person image in a camera image of either of the cameras, this means that the voxel does not overlap the person.

Therefore, if among the voxels 25 composing the detection wall 24, the number of voxels that are within person images in images of all cameras 1 and 2 is one or more, the collision detecting unit 12 judges that the person has collided with the detection wall 24.

On the contrary, if among the voxels 25 composing the detection wall 24, there is no voxel that is within person images in images of all cameras 1 and 2, it is judged that the person has not collided with the detection wall 24.

Thus, by means of the thin detection wall 24 composed of voxels, the fact that a person has entered the target space 20 can be detected. Furthermore, as mentioned above, by forming the detection wall 24 as thin as possible, the number of voxels to be examined by the collision detecting unit 12 is reduced. As a result, the amount of processing can be reduced and high-speed processing can be realized. The burden on system resources is correspondingly reduced.

Entry of a person can be detected using existing cameras for shooting surveillance images (installed in advance). Provision of other components, for example, an infrared-ray sensor for sensing passage of people in addition to the cameras, although permissible, is not necessary.

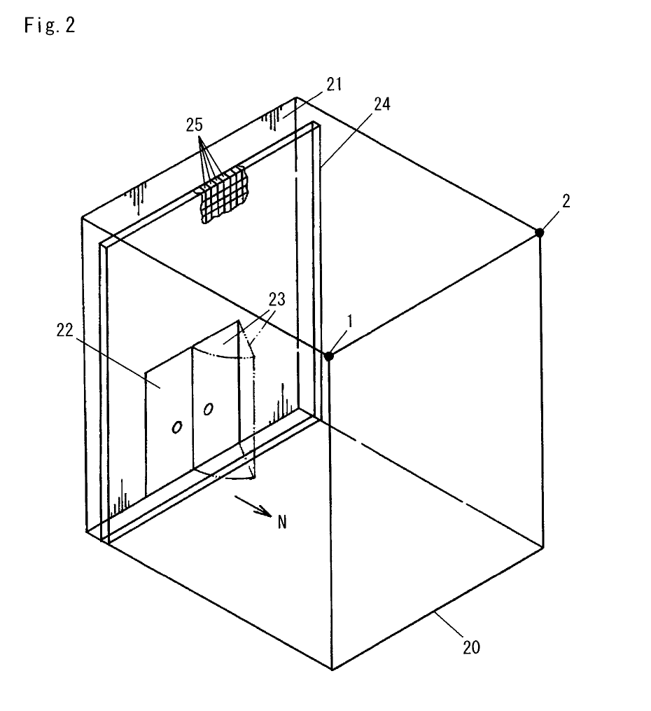

Although FIG. 2 shows a flat plane detection wall 24, the detection wall 24, since it is composed of virtual voxels, may be defined in any optional shape. The detection wall can be freely changed into, for example, a curved shape, a shape with a bent portion, steps, or a shape enclosed by two or more surfaces in accordance with a target to be captured by surveillance.

Incidentally, enclosure of a target to be captured by such a free encircling net is very difficult when using the abovementioned infrared ray sensor.

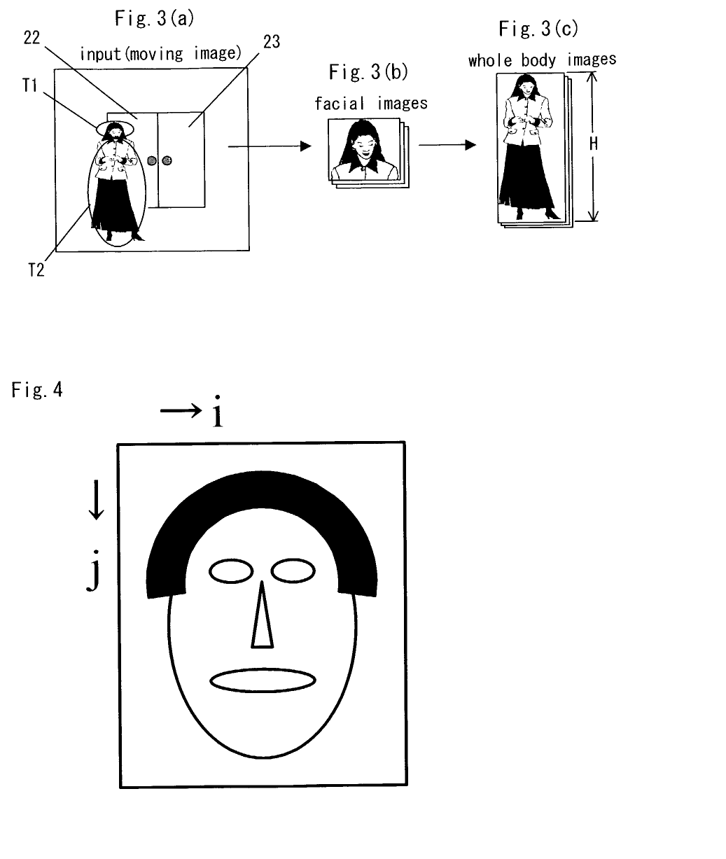

Referring now to FIG. 3, the essential image extracting unit 13 extracts essential images (facial images and whole body images) showing personal characteristics among images shot by the cameras 1 and 2.

A shot image is, for example, as shown in FIG. 3(a) in which doors 22 and 23 are included in the background. An image of a woman is detected in front of the doors 22 and 23 to the left of the image.

The essential image extracting unit 13 uses two templates to define the essential image of the woman. A first template T1 of a small ellipse that is long horizontally is used for face detection. A second template T2 of a large ellipse that is long vertically, is used for detection of portions other than the face. The essential image extracting unit 13 carries on template matching in the usual manner to calculate the correlation between the shot image and these templates T1 and T2, and calculates the point with maximum correlation in the shot image.

Referring now to FIGS. 3(a) and 3(b), as a result, when a sufficiently good match is obtained (comparison with threshold values may be properly made), the essential image extracting unit 13 extracts images in the vicinity of the template T1 as facial images. As shown in FIG. 3(c), images in the vicinity of both templates T1 and T2 are extracted as whole body images.

As essential images, facial images alone are usually sufficient in practical use. The method for extracting faces from the shot image is not limited to the abovementioned method. Other than this, for example, a method involving detection of face parts and a method involving extraction of skin-color regions can be optionally selected.

As shown in FIG. 3(c), the personal characteristics detecting unit 14 determines the height H of the whole body images extracted by the essential image extracting unit 13 as the height of a shot person as shown in FIG. 3(c). This height H can be easily determined from the number of voxels in the vertical direction of the whole body images since the geometric positions of the cameras 1 and 2 are known.

Referring now to FIG. 4, best shot selection by the best shot selecting unit 15 selects from several facial images the one which is most nearly a full facial image for determining the best shot. This shot is selected because the person face characteristics become most clear when the person turns his/her face frontward to directly face the cameras.

As described later, from the time a person collides with the detection wall 24 until the end of shoot of the person, a certain period of time elapses normally. Therefore, during the period, images of several frames are shot. In these several frames it is possible that several facial images of the person are obtained. The best shot selecting unit 15 selects an image in which the person is most clearly shot among these images.

Referring to FIG. 4, in the present embodiment, judgment of face direction is made. Concretely, the best shot selecting unit 15 has a template of a standard full face as shown in FIG. 4, and carries out matching between the facial images extracted by the essential image extracting unit 13 and this template. Then, a facial image that is best matched with the template is regarded as the best shot.

As another judgment of face direction, it is also allowed that the best shot selecting unit 15 determines an image with a maximum number of pixels within the skin color regions in a color space as a best shot.

Or, in place of the face direction judgment, a best shot can be determined by judging the timing. Herein, since the walking speed of a person can be ordinarily known, the time until the person is most clearly shot by the cameras 1 and 2 after a person collides with the detection wall 24 can be roughly estimated. Therefore, the best shot selecting unit 15 may determine a best shot as the shot taken at this time.

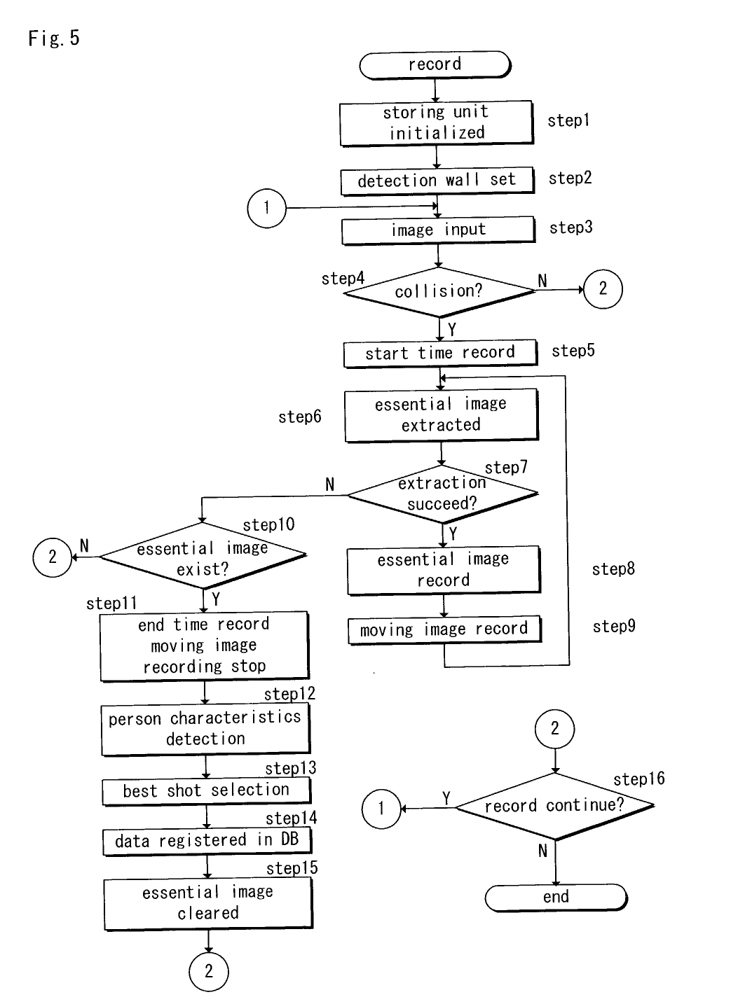

Referring now to FIG. 5, the shooting and recording flow by the surveillance recording device according to the present embodiment begins in step 1, wherein the control unit 4 clears the storing unit 10, and the detection wall setting unit 11 sets the detection wall 24 (step 2). Herein, the control unit 4 requires an operator to input detection wall information from the input unit 6, or if the information has already been known, the information may be loaded from an external storing unit.

Next, in step 3, the control unit 4 starts inputting images from the first camera 1 and second camera 2. Then, the control unit 4 directs the collision detecting unit 12 to detect whether or not a person has collided with the detection wall 24, and the collision detecting unit 12 feeds back detection results to the control unit 4.

If collision is not detected, the control unit 4 advances the process to step 16, and confirms that there are no instructions to end recording inputted from the input unit 6, which then returns the process to step 3.

When collision is detected, in step 5, the control unit 4 obtains current date and time information from the timer 5, and stores this date and time information as a start time into the storing unit 10.

Next, in step 6, the control unit 4 transmits a shot image to the essential image extracting unit 13 and commands the unit to extract essential images. Receiving this command, the essential image extracting unit 13 attempts to extract facial images and whole body images from the shot image.

At this point, when extraction is successfully carried out (step 7), the essential image extracting unit 13 adds facial images and whole body images into the storing unit 10 (step 8), and notifies the control unit 4 of the successful completion of extraction. Receiving this notification, the control unit 4 instructs the image recording and reproducing unit 9 to record the shot image as moving images. As a result, moving images are stored in the recording medium 90.

On the other hand, in step 7, when extraction has failed (for example, when a person is outside the fields of view of the cameras), the control unit 4 checks whether or not the essential images have been stored in the storing unit 10 in step 10.

When these have been stored, the control unit 4 judges that shooting of a person has been completed, and executes the next processing. First, in step 11, current date and time information is obtained from the timer 5, and stores this date and time information into the storing unit 10 as an end time.

In step 12, the control unit 4 transmits the whole body images in the storing unit 10 to the personal characteristics detecting unit 14, directs the unit to calculate height as a personal characteristic, and stores the calculation result into the storing unit 10. In step 13, the control unit 4 directs the best shot selecting unit 15 to select a best shot and obtains a selection result.

When the abovementioned processing is ended, the control unit 4 registers useful information including a best shot facial image, whole body image, start time, end time, and personal characteristics (moving image retrieval information) for retrieval of moving images in the database 17 by using the database engine 16 in step 14.

After completing registration, in step 15, the control unit 4 clears the moving image retrieval information in information stored in the storing unit 10, advances the process to step 16, and prepares for the next processing.

In step 10, when there is no essential image in the storing unit 10, the control unit 4 judges that the collision with the detection wall 24 was not caused by a person but by some other object, and advances the process to step 16, in preparation for the next processing.

In the processes mentioned above, the order of steps 11 through 13 may be freely interchanged.

By this construction, it can be understood that moving images in only a period in which a person is shot by the cameras after collision with the detection wall are detected are recorded in the storing unit 10. That is, useless recording in a period in which no person is shot by the cameras is omitted, thereby providing efficient operation is possible. In addition, moving image retrieval information is stored in the database 17. By using this information as an index, only important scenes can be easily retrieved and reproduced.

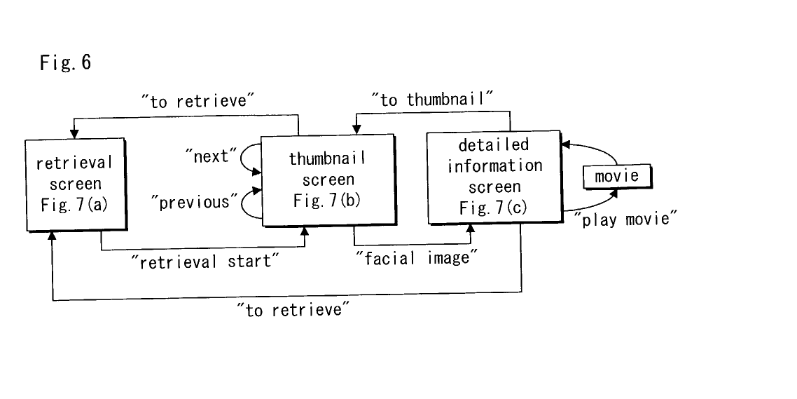

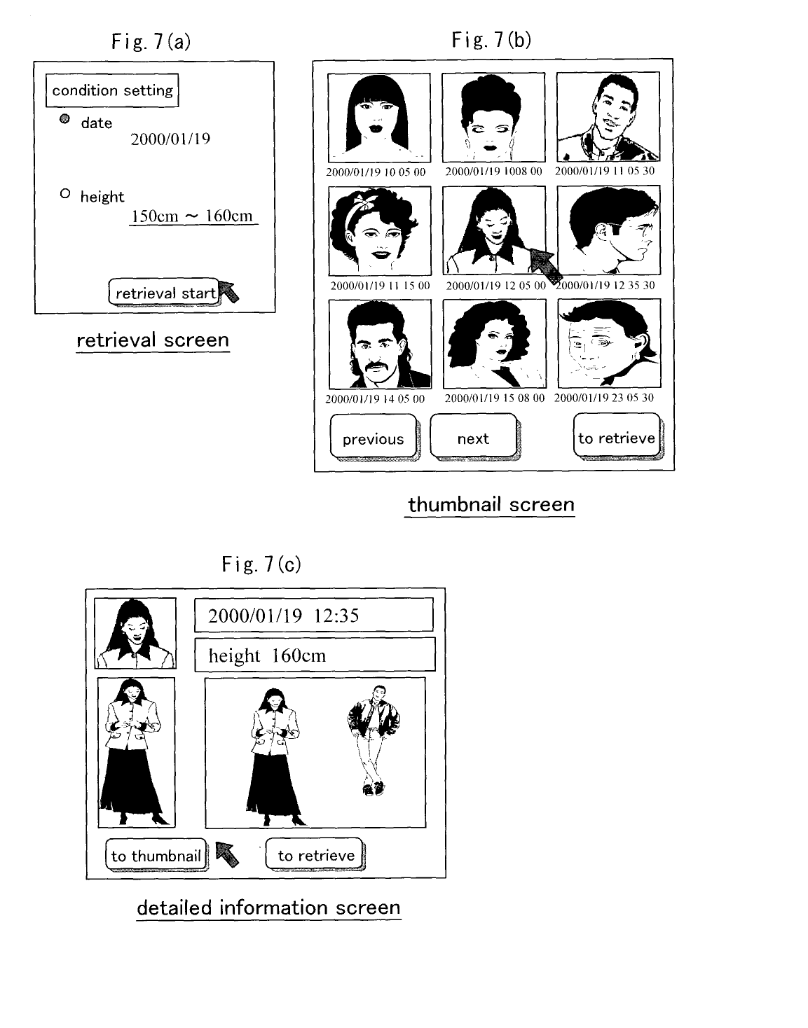

Next, the retrieval flow of surveillance results is explained with reference to FIG. 6 and FIG. 7. First, as shown in FIG. 6, in this retrieval, the display image generating unit 8 generates three types of screens, that is, a retrieval screen (FIG. 7(a)), thumbnail screen (FIG. 7(b)), and detailed information screen (FIG. 7(c)) in accordance with the circumstances, and displays them on the display unit 7.

These screens are changed from one to another in response to an operator clicking each button by using the input unit 6 as shown in FIG. 6.

First, in the retrieval screen shown in FIG. 7(a), the abovementioned moving image retrieval information (registered in the database 17) is inputted. In the example shown in the figure, a date and height are inputted. However are just one example, and the input information may be properly changed.

Then, when the moving image retrieval information is inputted and the retrieval start button is clicked, the control unit 4 directs the database engine 16 to retrieve a corresponding piece of moving image retrieval information. The retrieval results are transmitted to the display image generating unit 8.

Then, the display image generating unit 8 prepares thumbnails from corresponding facial images (best shots) and displays a list of thumbnails as shown in FIG. 7(b).

When there are many person candidates, and it is not possible to display all thumbnails at the same time, a next screen button and a previous screen button are displayed on the screen. Then, when the button is clicked, the remaining thumbnail images are listed and displayed.

An operator checks this list and searches data to be examined based on facial images and clicks the thumbnail which he/she wants to check.

Then, the control unit 4 informs the display image generating unit 8 of the desired thumbnail based on the information inputted through the input unit 6. Receiving this information, the display image generating unit 8 displays a detailed information screen as shown in FIG. 7(c). In this example, at this point, from moving image retrieval information corresponding to the desired thumbnail, a facial image (best shot), whole body image, start time, and personal characteristics (height) are retrieved and displayed. In addition, a corresponding moving image of the recording medium 90 from this start time is displayed at the same time.

The display patterns shown in the figures are illustrations, and they may be properly changed for easy observation.

Herein, in this example, retrieval is carried out in the retrieval screen first. However, when the amount of data registered in the database 17 is small, it is also allowed that the retrieval process is omitted, and whole data is displayed on the thumbnail screen and selection of a target person is made.

The thumbnail images and shooting time are displayed together on the thumbnail screen. However, in addition to the shooting time, other personal characteristics that can be registered into the database 17, such as, for example, gender, age and the like may be displayed.

As shown in the figure, when a moving image is simultaneously displayed, incidental circumstances such as the number of persons and characters who entered at the same time with a target person can be grasped. This makes it easier to identify accomplices.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A surveillance recording device comprising:
at least one camera for shooting a target space;
an image recording and reproducing means for recording images shot by said cameras in a recording medium, and reproducing images from said recording medium;
an essential image extracting means for extracting essential images of a person from said images shot by said cameras; and
a retrieval information recording means for recording retrieval information including said essential images.

2. The surveillance recording device according to claim 1, wherein said essential images include facial images of said person.

3. The surveillance recording device according to claim 1, wherein said essential images include whole body images of said person.

4. The surveillance recording device according to claim 1, further comprising:
a personal characteristics detecting means for detecting personal characteristics based on said essential images extracted by said essential image extracting means; and
said retrieval information includes said personal characteristics.

5. The surveillance recording device according to claim 4, wherein said personal characteristics include a height of said person.

6. The surveillance recording device according to claim 2, further comprising:
a best shot selecting means for selecting a best shot among facial images of said person; and
said retrieval information includes said best shot facial image.

7. The surveillance recording device according to claim 2, further comprising:
a display means;
a display image generating means for generating display images to be displayed by said display means; and
said display image generating means includes means for generating a thumbnail screen for displaying a list of essential images of people.

8. The surveillance recording device according to claim 7, wherein:
said display image generating means includes means for generating a detailed information screen relating to a specified thumbnail on said thumbnail screen;
and said detailed information screen includes essential images, characteristics, and shooting times of people.

9. The surveillance recording device according to claim 1, wherein said image recording and reproducing means is effective to record images only in sections in which said essential image extracting means can extract essential images of people onto said recording medium.

10. A surveillance recording device comprising:
at least one camera for shooting a target space;
an image recording and reproducing means for recording images shot by said cameras onto a recording medium and for reproducing images from said recording medium;
a detection wall setting means for defining a detection wall for detecting entry of people into a target space;
a collision detecting means for detecting whether or not a person has collided with said detection wall;
said detection wall is a virtual wall composed of a plurality of voxels depending on positional relationship of said cameras;
a thickness of said detection wall is set to be small with respect to a depth of said target space.

11. The surveillance recording device according to claim 10, wherein:
said essential image extracting means includes means for extracting essential images of a person only after said collision detecting means detects collision of a person; and
said retrieval information includes a time at which said collision detecting means detects collision of said person.

12. The surveillance recording device according to claim 10, wherein said image recording and reproducing means includes means for starting recording images shot by said cameras after said collision detecting means detects collision of a person.

13. A surveillance recording device comprising:
at least one camera for shooting a target space;
an image recording and reproducing means for recording images shot by said cameras onto a recording medium and for reproducing images from said recording medium;
an essential image extracting means for extracting essential images of an object from images shot by said cameras; and
a retrieval information recording means for recording retrieval information including said essential images.

14. A surveillance recording method in which a target space is shot by cameras and shot images are recorded onto a recording medium, comprising:
means for extracting essential images of an object from said images shot by said cameras; and
means for retrieving information including said essential images associated with said images shot by said cameras and recorded.

15. A surveillance recording method in which a target space is shot by cameras and said shot images are recorded onto a recording medium, comprising:
extracting essential images of a person from said images shot by said cameras, and retrieval information including said essential images associated with said images shot by said cameras and recorded.

16. The surveillance recording method according to claim 15, wherein said essential images include facial images of said person.

17. The surveillance recording method according to claim 15, wherein said essential images include whole body images of said person.

18. The surveillance recording method according to claim 15, further comprising detecting at least one personal characteristic based on essential images and said personal characteristic is included in said retrieval information.

19. The surveillance recording method according to claim 18, wherein said personal characteristic includes a height of said person.

20. The surveillance recording method according to claim 16, further comprising selecting a best shot among facial images of said person and including said best shot facial image in said retrieval information.

21. The surveillance recording method according to claim 16, further comprising displaying a thumbnail screen containing a list of essential images of people.

22. The surveillance recording method according to claim 21, further comprising displaying a detailed information screen including essential images of a person, personal characteristics, and person shooting times that relate to a specified thumbnail selected from said thumbnail screen.

23. The surveillance recording method according to claim 15, further comprising recording images onto said recording medium only in sections in which essential images of people have been extracted.

24. A surveillance recording method further comprising:
at least stereoscopically shooting a target space and recording shot images onto a recording medium;
defining a virtual detection wall;
said step of defining includes defining a virtual detection wall composed of a plurality of voxels depending on said positional relationship of said cameras;
assigning a thickness to said virtual detection wall that is small with respect to a depth of said target space; and
detecting an entry of a person into said target space by detecting whether or not said person has collided with said detection wall.

25. The surveillance recording device according to claim 24, further comprising:
starting extracting of essential images of a person after detecting that said person has collided with said detection wall; and
including a time at which said person collides with said detection wall in said retrieval information.

26. The surveillance recording method according to claim 24, further comprising starting recording of images shot by said cameras only after detecting that a person has collided with said detection wall.
